(19) United States
(12) Patent Application Publication
(10) Pub. No.: US 2013/0234819 A1
(43) Pub. Date: Sep. 12, 2013

(54) THIN FILM TYPE COMMON MODE FILTER

(71) Applicant: SAMSUNG ELECTRO-MECHANICS CO., LTD., Suwon-si (KR)

(72) Inventors: Young Seuck YOO, Suwon (KR); Sung Kwon WI, Suwon (KR); Jong Yun LEE, Suwon (KR); Sang Moon LEE, Suwon (KR); Won Chul SIM, Suwon (KR); Jeong Bok KWAK, Suwon (KR); Kang Heon HUR, Suwon (KR); Yong Suk KIM, Suwon (KR)

(73) Assignee: SAMSUNG ELECTRO-MECHANICS CO., LTD., Suwon-si (KR)

(21) Appl. No.: 13/766,449

(22) Filed: Feb. 13, 2013

(30) Foreign Application Priority Data
Mar. 6, 2012 (KR) 10-2012-0022904

(51) Int. Cl. H01F 17/00

(52) U.S. Cl. CPC H01F 17/0013
USPC 336/200

(57) ABSTRACT

The present invention relates to a common mode filter and a method of manufacturing the same and provides a thin film type common mode filter including: a first magnetic substrate; a first laminate disposed on the first magnetic substrate and including a primary coil pattern electrode; a core magnetic layer disposed on the first laminate; a second laminate disposed on the core magnetic layer and including a secondary coil pattern electrode; and a second magnetic substrate disposed on the second laminate.

### CROSS-REFERENCE TO RELATED APPLICATIONS

Claim and incorporate by reference domestic priority application and foreign priority application as follows:

### Cross Reference to Related Application

This application claims the benefit under 35 U.S.C. Section 119 of Korean Patent Application Serial No. 10-2012-0022904, entitled filed Mar. 6, 2012, which is hereby incorporated by reference in its entirety into this application.

### BACKGROUND OF THE INVENTION

1. Field of the Invention

The present invention relates to a common mode filter, and more particularly, to a thin film type common mode filter having a core magnetic layer made of a magnetic material between primary and secondary coil pattern electrodes which are spaced apart from each other.

2. Description of the Related Art

In recent times, there is a need for high transmission speed due to system configuration and increases in data capacity. As a high speed transmission method, a differential signaling method is mainly used. In general, when converting a signal into a radio frequency in order to increase transmission speed, undesired electromagnetic waves (that is, noise) are generated according to the conversion of the signal into a radio frequency so that the signal and the noise are overlapped with each other. Accordingly, common mode noise is generated due to unbalance between high speed differential signal lines (that is, two signal lines).

A common mode filter is mainly used to remove this common mode noise. The common mode filter is an EMI filter which is mainly applied to the high speed differential signal line.

The common mode noise is noise generated in the differential signal line, and the common mode filter removes such noise, which can not be removed by an existing EMI filter. The common mode filter contributes to improvement of EMI characteristics of home appliances or antenna characteristics of mobile phones.

However, when a large amount of data are communicated between a main device and a peripheral device over a GHz radio frequency band, as described above, it is difficult to smoothly process data due to signal delay and other obstacles. Especially, in various port to port connection of communication, video, and audio signal lines such as digital TVs, the above-described internal signal line delay and transmission/reception distortion more frequently occur.

In order to solve the above problem, existing EMI prevention parts (for example, common mode filter) are manufactured in coil type or stack type, but the coil type or stack type EMI prevention parts are applied only to specific portions or large-area circuit boards since they have a large chip part size and poor electrical characteristics.

Moreover, in these days, since electronic products have been developed to have slim, miniaturized, complex, and multifunctional characteristics, a common mode filter that meets these characteristics are on the rise. Although the coil type or stack type common mode filter, which corresponds to the slim and miniaturized electronic products, has been manufactured, since there is a limitation in forming a complex internal circuit in a small area, recently, there is a need for manufacture of a thin film type common mode filter.

In order to improve electrical characteristics of coil parts, it is an important task to increase electromagnetic coupling between a primary coil and a secondary coil. In order to increase the electromagnetic coupling between the primary and secondary coils, an interval between the two coils should be reduced or a magnetic loop should be formed to prevent generation of leakage flux.

In case of a thin film type common mode filter, since it is manufactured by thin film forming techniques such as sputtering, evaporation, and area deposition so that the interval between the primary and secondary coils can be reduced to several μm, it is possible to increase electromagnetic coupling compared to conventional products and achieve miniaturization of parts but there are disadvantages that manufacturing costs are increased and productivity is deteriorated compared to the coil type or stack type common mode filter.

In relation to this, Korean Application Laid-open No. 10-2002-0059899 (hereinafter, related art document) proposes a coil part which includes an internal electrode layer formed of at least two layers and including a non-magnetic electrode layer having an electrode pattern on at least one of a top surface and a bottom surface and an internal magnetic layer positioned in a center opening of the non-magnetic electrode layer and side surfaces of the non-magnetic electrode layer as one unit, a cover layer in contact with both surfaces of the internal electrode layer, and an external electrode terminal connected to a portion of the electrode pattern.

When describing a method of manufacturing this coil part in brief, first, green sheets in which a magnetic film and a non-magnetic film are respectively formed on carrier films are prepared.

Next, cutting lines are formed on the magnetic film and non-magnetic film green sheets, and a via-hole is formed in the non-magnetic film green sheet with the cutting line.

Next, an electrode pattern is formed on a top surface of the non-magnetic film green sheet with the via-hole, and unnecessary portions of the magnetic film and non-magnetic film green sheets are removed.

Next, the proposed coil part is manufactured through processes of laminating the magnetic film green sheet, the magnetic green sheet with the cutting line, the non-magnetic film green sheet with the cutting line, and the non-magnetic film green sheet with the via-hole and the electrode pattern, sintering the laminate, and forming an electrode terminal on an outer surface of the sintered laminate.

However, unlike the stack type common mode filter, in case of the thin film type common mode filter manufactured by the thin film forming techniques such as sputtering, evaporation, and aero deposition, it is not easy to dispose a core in a center portion of a coil pattern electrode with the dry manufacturing method proposed in the related art document to improve characteristics of the common mode filter.

In the thin film type common mode filter, since the interval between the coil pattern electrodes is just several pm and a thickness of an insulation sheet on which the coil pattern electrode is printed is also very small, that is, several mm, it is very hard to stably form a vertical interface between a non-magnetic body and a magnetic body, and particularly, it is very hard to appropriately adjust a thickness of an internal electrode, a thickness of the non-magnetic body, and a thickness of the magnetic body in a vertical direction. Due to this, structural stability weakens, thus eventually causing problems on insulation between the coils and so on.

Further, since one layer is configured by laminating the magnetic body and the non-magnetic body after punching the magnetic body and the non-magnetic body of each layer and half-cutting the magnetic body and the non-magnetic body according to needs, a manufacturing method is complicated and manufacturing costs are also increased.

### RELATED ART DOCUMENT

### Patent Document

Patent Document 1: Korean Patent Laid-open Publication No. 10-2002-0059899

### SUMMARY OF THE INVENTION

The present invention has been invented in order to overcome the above-described problems and it is, therefore, an object of the present invention to provide a common mode filter having a core magnetic layer made of a magnetic material between primary and secondary coil pattern electrodes which are spaced apart from each other while using an existing thin film forming technique as it is.

In accordance with one aspect of the present invention to achieve the object, there is provided a thin film type common mode filter including: a first magnetic substrate; a first laminate disposed on the first magnetic substrate and including a primary coil pattern electrode; a core magnetic layer disposed on the first laminate; a second laminate disposed on the core magnetic layer and including a secondary coil pattern electrode; and a second magnetic substrate disposed on the second laminate.

At this time, the first laminate is formed by laminating at least one insulation sheet having an internal electrode on one surface.

And, when the insulation sheets are at least two, the internal electrodes formed on the respective insulation sheets are connected through a via-hole to form the primary coil pattern electrode.

Further, the second laminate is formed by laminating at least one insulation sheet having an internal electrode on one surface.

Further, when the insulation sheets are at least two, the internal electrodes formed on the respective insulation sheets are connected through a via-hole to form the secondary coil pattern electrode.

Further, the internal electrode is formed by one method of photolithography, E-beam or focused ion beam lithography, dry etching, wet etching, and nano-imprinting.

Further, when the insulation sheets are at least two, each insulation sheet is deposited by at least one method of chemical vapor deposition (CVD), physical vapor deposition (PVD) such as sputtering, evaporation, aero deposition, cold spraying, molecular beam epitaxy (MBE), and atom layer deposition (ALD), and silk screening.

Further, the first and second magnetic substrates and the core magnetic layer are made of the same material.

Further, the first and second magnetic substrates and the core magnetic layer are made of at least one material or a mixture of at least two materials selected from aluminum oxides (Al₂O₃), aluminum nitrides (AlN), glass, quartz, and ferrite.

Further, the insulation sheet is made of at least one material or a mixture of at least two materials selected from polyimide, epoxy resins, benzocyclobutene (BCB), and polymers.

Further, the thin film type common mode filter further includes external electrode terminals which are connected to one end and the other end of the primary coil pattern electrode and one end and the other end of the secondary coil pattern electrode, respectively.

Further, the thin film type common mode filter further includes insulation films disposed between the first laminate and the core magnetic layer and between the second laminate and the second magnetic substrate.

In accordance with another aspect of the present invention to achieve the object, there is provided a thin film type common mode filter including: a first magnetic substrate; a first laminate disposed on the first magnetic substrate and formed by laminating a plurality of insulation sheets each having an internal electrode on one surface; a core magnetic layer disposed on the first laminate; a second laminate disposed on the core magnetic layer and formed by laminating a plurality of insulation sheets each having an internal electrode on one surface; and a second magnetic substrate disposed on the second laminate.

At this time, an internal electrode formed on a first insulation sheet constituting the first laminate and an internal electrode formed on a third insulation sheet constituting the second laminate are connected through a via-hole to form a primary coil pattern electrode, and an internal electrode formed on a second insulation sheet constituting the first laminate and an internal electrode formed on a fourth insulation sheet constituting the second laminate are connected through a via-hole to form a secondary coil pattern electrode.

And, the internal electrode is formed by one method of photolithography, E-beam or focused ion beam lithography, dry etching, wet etching, and nano-imprinting.

Further, the plurality of insulation sheets are deposited by at least one method of chemical vapor deposition (CVD), physical vapor deposition (PVD) such as sputtering, evaporation, aero deposition, cold spraying, molecular beam epitaxy (MBE), and atom layer deposition (ALD), and silk screening.

Further, the first and second magnetic substrates and the core magnetic layer are made of the same material.

Further, the first and second magnetic substrates and the core magnetic layer are made of at least one material or a mixture of at least two materials selected from aluminum oxides (Al₂O₃), aluminum nitrides (AlN), glass, quartz, and ferrite.

Further, the insulation sheet is made of at least one material or a mixture of at least two materials selected from polyimide, epoxy resins, benzocyclobutene (BCB), and polymers.

Further, the thin film type common mode filter further includes insulation films disposed between the first laminate and the core magnetic layer and between the second laminate and the second magnetic substrate.

Further, the thin film type common mode filter further includes external electrode terminals which are connected to one end and the other end of the primary coil pattern electrode and one end and the other end of the secondary coil pattern electrode, respectively.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is an exploded perspective view of a thin film type common mode filter in accordance with the present invention;

FIG. 2 is a graph of impedance characteristics of the thin film type common mode filter in accordance with the present invention;

FIG. 3 is an external perspective view of the thin film type common mode filter in accordance with the present invention; and

FIG. 4 is an exploded perspective view of a thin film type common mode filter in accordance with another embodiment of the present invention.

### DETAILED DESCRIPTION OF THE PREFERABLE EMBODIMENTS

Advantages and features of the present invention and methods of accomplishing the same will be apparent by referring to embodiments described below in detail in connection with the accompanying drawings. However, the present invention is not limited to the embodiments disclosed below and may be implemented in various different forms. The exemplary embodiments are provided only for completing the disclosure of the present invention and for fully representing the scope of the present invention to those skilled in the art. Like reference numerals refer to like elements throughout the specification.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Hereinafter, configuration and operational effect of the present invention will be described in detail with reference to the accompanying drawings.

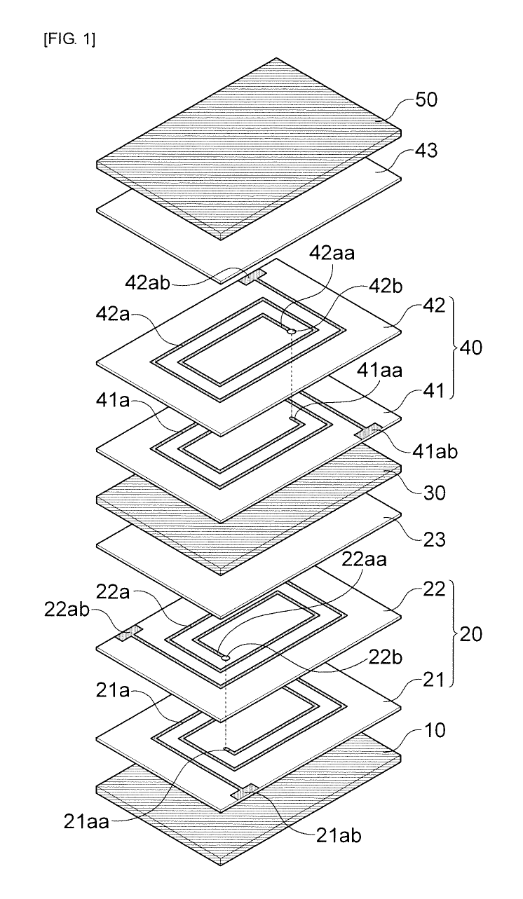

FIG. 1 is an exploded perspective view of a thin film type common mode filter in accordance with the present invention.

Referring to FIG. 1, a thin film type common mode filter in accordance with the present invention may include a first magnetic substrate 10, a first laminate 20 disposed on the first magnetic substrate 10, a core magnetic layer 30 disposed on the first laminate 20, a second laminate 40 disposed on the core magnetic layer 30, and a second magnetic substrate 50 disposed on the second laminate 40.

The first magnetic substrate 10 and the second magnetic substrate 50 are formed in a long plate shape and become base substrates in the completed common mode filter. That is, in the completed common mode filter, the first magnetic substrate 10 and the second magnetic substrate 50 may be positioned in the uppermost and lowermost portions of the common mode filter, respectively, as a pair.

These first magnetic substrate 10 and second magnetic substrate 50 are made of a magnetic material to form a magnetic loop. Therefore, it is preferred to use the magnetic substrate with high magnetic permeability, quality factor, and high-frequency impedance.

Specifically, the first magnetic substrate 10 and the second magnetic substrate 50 may be made of at least one material or a mixture of at least two materials selected from aluminum oxides (Al₂O₃), aluminum nitrides (AlN), glass, quartz, and ferrite.

The first laminate 20 may include a primary coil pattern electrode, and the second laminate 40 may include a secondary coil pattern electrode.

Here, the coil pattern electrode is a coil-shaped conductor pattern which generates a magnetic field by a current conducted when power is applied to the common mode filter, and this coil pattern electrode may be formed by electrically connecting conductor patterns printed on respective insulation sheets through a via-hole.

When looking into structures of the first laminate 20 and the second laminate 40 in detail, the first laminate 20 and the second laminate 40 may be formed by laminating at least one insulation sheet having an internal electrode on one surface. The internal electrode may be made of at least one material or a mixture of at least two materials selected from silver (Ag), palladium (Pd), aluminum (Al), nickel (Ni), titanium (Ti), gold (Au), copper (Cu), and platinum (Pt). In addition, the internal electrode can be made of other materials with high conductivity.

The insulation sheet prevents the internal electrodes formed on the insulation sheets from shorting each other while giving interlayer adhesion and performs a function of reducing unevenness due to the internal electrodes. This insulation sheet may be made of at least one material or a mixture of at least two materials selected from polyimide, epoxy resins, benzocyclobutene (BCB), and polymers.

When the insulation sheets are at least two, the internal electrodes formed on the respective insulation sheets are connected through a via-hole formed on the upper insulation sheet to form the primary coil pattern electrode.

As an example, as shown in FIG. 1, one end 21aa of a first internal electrode 21a formed on a first insulation sheet 21 is electrically connected to one end 22aa of a second internal electrode 22a through a via-hole 22b formed in a second insulation sheet 22 positioned on a top surface of the first insulation sheet 21 to form the primary coil pattern electrode.

And, one end 41aa of a third internal electrode 41a formed on a third insulation sheet 41 is electrically connected to one end 42aa of a fourth internal electrode 42a through a via-hole 42b formed in a fourth insulation sheet 42 positioned on a top surface of the third insulation sheet 41 to form the secondary coil pattern electrode.

At this time, the internal electrodes formed on the respective insulation sheets may be formed by one method of photolithography, E-beam or focused ion beam lithography, dry etching, wet etching, and nano-imprinting.

Further, the respective insulation sheets may be sequentially deposited by at least one of thin film forming techniques such as chemical vapor deposition (CVD), physical vapor deposition (PVD) such as sputtering, evaporation, aero deposition, cold spraying, molecular beam epitaxy (MBE), and atom layer deposition (ALD), and silk screening. Since these thin film forming techniques are generally well-known techniques to those skilled in the art, detailed description of this will be omitted.

Since the core magnetic layer 30 disposed between the first laminate 20 and the second laminate 40 forms a magnetic loop with the first and second magnetic substrates 10 and 50, it is preferred that the core magnetic layer 30 is made of the same material as the first and second magnetic substrates 10 and 50. Therefore, the core magnetic layer 30 may be made of at least one material or a mixture of at least two materials selected from aluminum oxides (Al₂O₃), aluminum nitrides (AlN), glass, quartz, and ferrite.

This core magnetic layer 30, like the insulation sheet constituting the first and second laminates, may be deposited on the first laminate 20 by at least one of the above-described thin film forming techniques.

Like this, since the thin film type common mode filter in accordance with the present invention can be manufactured using an existing thin film forming technique as it is, it is possible to secure structural stability and high coupling coefficient, reduce manufacturing costs, and improve productivity of products.

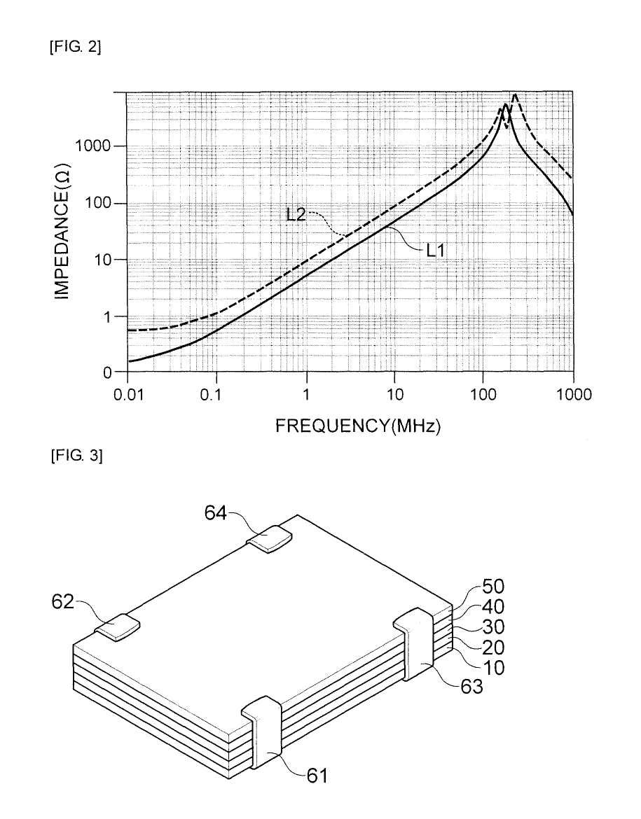

FIG. 2 is a graph for comparing impedance characteristics of the thin film type common mode filter in accordance with the present invention and a conventional common mode filter. Here, a curve L1 is a graph of impedance characteristics of the conventional common mode filter in which laminates including primary and secondary coil pattern electrodes are disposed between upper and lower magnetic substrates, and a curve L2 is a graph of impedance characteristics of the thin film type common mode filter in accordance with the present invention.

Referring to FIG. 2, since the thin film type common mode filter in accordance with the present invention disposes the core magnetic layer 30 between the first laminate 20 and the second laminate 40, it is possible to check that common mode impedance in a low frequency band is increased compared to the conventional common mode filter and a self resonance frequency (SRF) band moves more to a high frequency band.

Meanwhile, the thin film type common mode filter in accordance with the present invention may further include an insulation film 23 between the first laminate 20 and the core magnetic layer 30 and likewise may further include an insulation film 43 between the second laminate 40 and the second magnetic substrate 50.

Generally, since the core magnetic layer 30, which is made of a magnetic material, is poor in insulation property, the insulation films 23 and 43 are provided to secure insulation with the internal electrode formed on the second insulation sheet 22.

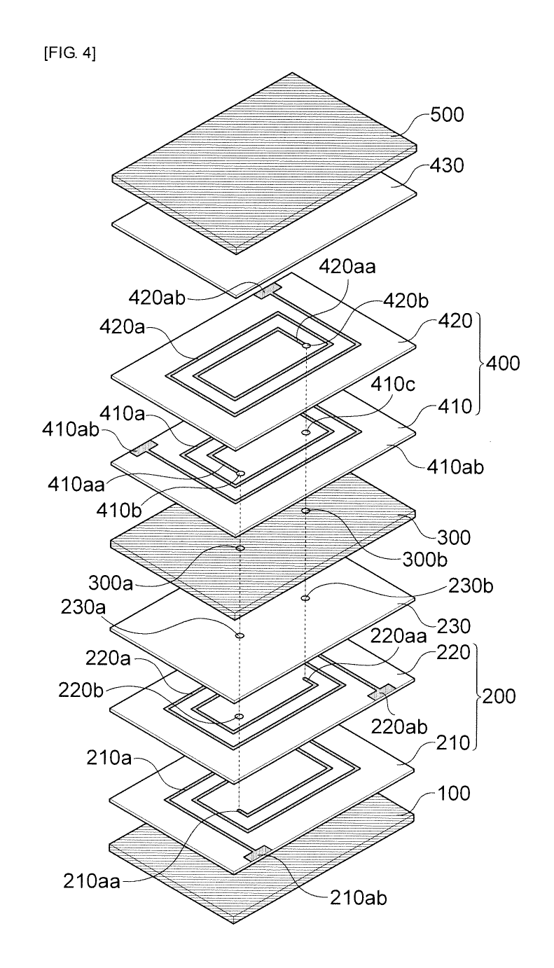

FIG. 3 is an external perspective view of the thin film type common mode filter in accordance with the present invention, and as shown in FIG. 3, the thin film type common mode filter in accordance with the present invention may additionally include external electrode terminals 61, 62, 63, and 64.

When describing more specifically with reference to FIGS. 1 to 3, an electrode 21ab drawn from the other end of the first internal electrode 21a is connected to the external electrode terminal 61, and an electrode 22ab drawn from the other end of the second internal electrode 22a is connected to the external electrode terminal 62. And, an electrode 41ab drawn from the other end of the third internal electrode 41a is connected to the external electrode terminal 63, and an electrode 42ab drawn from the other end of the second internal electrode 42a is connected to the external electrode terminal 64.

Accordingly, the primary and secondary coil pattern electrodes are electrically connected to external circuits through the external electrode terminals 61, 62, 63, and 64.

Now, a thin film type common mode filter in accordance with another embodiment of the present invention will be described.

FIG. 4 is an exploded perspective view of a thin film type common mode filter in accordance with another embodiment of the present invention.

Referring to FIG. 4, a thin film type common mode filter in accordance with another embodiment of the present invention may include a first magnetic substrate 100, a first laminate 200 disposed on the first magnetic substrate 100, a core magnetic layer 300 disposed on the first laminate 200, a second laminate 400 disposed on the core magnetic layer 300, and a second magnetic substrate 500 disposed on the second laminate 400.

Further, in order to secure insulation property, the thin film type common mode filter in accordance with the present invention may further include an insulation film 230 between the first laminate 200 and the core magnetic layer 300 and likewise may further include an insulation film 430 between the second laminate 400 and the second magnetic substrate 500.

Since the first magnetic substrate 100 and the second magnetic substrate 500, which are made of a magnetic material, form a magnetic loop, it is preferred to use the magnetic substrate with high magnetic permeability, quality factor, and high-frequency impedance. Specifically, the first magnetic substrate 100 and the second magnetic substrate 500 may be made of at least one material or a mixture of at least two materials selected from aluminum oxides (Al₂O₃), aluminum nitrides (AlN), glass, quartz, and ferrite.

The first laminate 200 is disposed on the first magnetic substrate 100 and may be formed by laminating a plurality of insulation sheets each having an internal electrode on one surface, and likewise, the second laminate 400 may be formed by laminating a plurality of insulation sheets each having an internal electrode on one surface.

When looking into structures of the first laminate 200 and the second laminate 400 in detail, as shown in FIG. 4, a first internal electrode 210a is formed on one surface of a first insulation sheet 210 constituting the first laminate 200, and a second internal electrode 220a is formed on one surface of a second insulation sheet 220. And, a third internal electrode 410a is formed on one surface of a third insulation sheet 410 constituting the second laminate 400, and a fourth internal electrode 420a is formed on one surface of a fourth insulation sheet 420.

One end 210aa of the first internal electrode 210a formed on the first insulation sheet 210 is electrically connected to one end 410aa of the third internal electrode 410a through a via-hole 220b formed in the second insulation sheet 220, a via-hole 230a formed in the insulation film 230, a via-hole 300a formed in the core magnetic layer 300, and a via-hole 410b formed in the third insulation sheet 410 to form a primary coil pattern electrode.

And, one end 220aa of the internal electrode 220a formed on the second insulation sheet 220 is electrically connected to one end 420aa of the fourth internal electrode 420a through a via-hole 230b formed in the insulation film 230, a via-hole 300b formed in the core magnetic layer 300, a via-hole 410c formed in the third insulation sheet 410, and a via-hole 420b formed in the fourth insulation sheet 420 to form a secondary coil pattern electrode.

The plurality of insulation sheets may be sequentially deposited by at least one of thin film forming techniques such as chemical vapor deposition (CVD), physical vapor deposition (PVD) such as sputtering, evaporation, aero deposition, cold spraying, molecular beam epitaxy (MBE), and atom layer deposition (ALD), and silk screening.

And, the core magnetic layer 300 disposed between the first laminate 200 and the second laminate 400 may be deposited on the first laminate 200 by at least one of the above-described several thin film forming techniques, like the respective insulation sheets constituting the first laminate 200 and the second laminate 400.

Like this, since the thin film type common mode filter in accordance with the present invention can be manufactured using an existing thin film forming technique as it is, it is possible to secure structural stability and high coupling coefficient, reduce manufacturing costs, and improve productivity of products.

Meanwhile, the common mode filter in accordance with another embodiment of the present invention may be electrically connected to external circuits by additionally including external electrode terminals (not shown) which are connected to an electrode 210ab drawn from the other end of the first internal electrode 210a, an electrode 220ab drawn from the other end of the second internal electrode 220a, an electrode 410ab drawn from the other end of the third internal electrode 410a, and an electrode 420ab drawn from the other end of the second internal electrode 420a.

In accordance with the thin film type common mode filter in accordance with the present invention, since the core magnetic layer, which is made of a magnetic material, is disposed between the laminates including the coil pattern electrodes, common mode impedance in a low frequency band is increased compared to the conventional common mode filter, and a self resonance frequency (SRF) band moves more to a high frequency band.

And, since the thin film type common mode filter in accordance with the present invention can be manufactured using an existing thin film forming technique as it is, it is possible to secure structural stability and high coupling coefficient, reduce manufacturing costs, and improve productivity of products.

The foregoing description illustrates the present invention. Additionally, the foregoing description shows and explains only the preferred embodiments of the present invention, but it is to be understood that the present invention is capable of use in various other combinations, modifications, and environments and is capable of changes and modifications within the scope of the inventive concept as expressed herein, commensurate with the above teachings and/or the skill or knowledge of the related art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

What is claimed is:

1. A thin film type common mode filter comprising:
a first magnetic substrate;
a first laminate disposed on the first magnetic substrate and including a primary coil pattern electrode;
a core magnetic layer disposed on the first laminate;
a second laminate disposed on the core magnetic layer and including a secondary coil pattern electrode; and
a second magnetic substrate disposed on the second laminate.

2. The thin film type common mode filter according to claim 1, wherein the first laminate is formed by laminating at least one insulation sheet having an internal electrode on one surface.

3. The thin film type common mode filter according to claim 2, wherein when the insulation sheets are at least two, the internal electrodes formed on the respective insulation sheets are connected through a via-hole to form the primary coil pattern electrode.

4. The thin film type common mode filter according to claim 1, wherein the second laminate is formed by laminating at least one insulation sheet having an internal electrode on one surface.

5. The thin film type common mode filter according to claim 4, wherein when the insulation sheets are at least two, the internal electrodes formed on the respective insulation sheets are connected through a via-hole to form the secondary coil pattern electrode.

6. The thin film type common mode filter according to claim 2 or 4, wherein the internal electrode is formed by one method of photolithography, E-beam or focused ion beam lithography, dry etching, wet etching, and nano-imprinting.

7. The thin film type common mode filter according to claim 2 or 4, wherein when the insulation sheets are at least two, each insulation sheet is deposited by at least one method of chemical vapor deposition (CVD), physical vapor deposition (PVD) such as sputtering, evaporation, aero deposition, cold spraying, molecular beam epitaxy (MBE), and atom layer deposition (ALD), and silk screening.

8. The thin film type common mode filter according to claim 1, wherein the first and second magnetic substrates and the core magnetic layer are made of the same material.

9. The thin film type common mode filter according to claim 8, wherein the first and second magnetic substrates and the core magnetic layer are made of at least one material or a mixture of at least two materials selected from aluminum oxides (Al₂O₃), aluminum nitrides (AlN), glass, quartz, and ferrite.

10. The thin film type common mode filter according to claim 2 or 4, wherein the insulation sheet is made of at least one material or a mixture of at least two materials selected from polyimide, epoxy resins, benzocyclobutene (BCB), and polymers.

11. The thin film type common mode filter according to claim 1, further comprising:
external electrode terminals which are connected to one end and the other end of the primary coil pattern electrode and one end and the other end of the secondary coil pattern electrode, respectively.

12. The thin film type common mode filter according to claim 1, further comprising:
insulation films disposed between the first laminate and the core magnetic layer and between the second laminate and the second magnetic substrate.

13. A thin film type common mode filter comprising:
a first magnetic substrate;
a first laminate disposed on the first magnetic substrate and formed by laminating a plurality of insulation sheets each having an internal electrode on one surface;
a core magnetic layer disposed on the first laminate;
a second laminate disposed on the core magnetic layer and formed by laminating a plurality of insulation sheets each having an internal electrode on one surface; and
a second magnetic substrate disposed on the second laminate.

14. The thin film type common mode filter according to claim 13, wherein an internal electrode formed on a first insulation sheet constituting the first laminate and an internal electrode formed on a third insulation sheet constituting the second laminate are connected through a via-hole to form a primary coil pattern electrode, and an internal electrode formed on a second insulation sheet constituting the first laminate and an internal electrode formed on a fourth insulation sheet constituting the second laminate are connected through a via-hole to form a secondary coil pattern electrode.

15. The thin film type common mode filter according to claim 13, wherein the internal electrode is formed by one method of photolithography, E-beam or focused ion beam lithography, dry etching, wet etching, and nano-imprinting.

16. The thin film type common mode filter according to claim 13, wherein the plurality of insulation sheets are deposited by at least one method of chemical vapor deposition (CVD), physical vapor deposition (PVD) such as sputtering, evaporation, aero deposition, cold spraying, molecular beam epitaxy (MBE), and atom layer deposition (ALD), and silk screening.

17. The thin film type common mode filter according to claim 13, wherein the first and second magnetic substrates and the core magnetic layer are made of the same material.

18. The thin film type common mode filter according to claim 17, wherein the first and second magnetic substrates and the core magnetic layer are made of at least one material or a mixture of at least two materials selected from aluminum oxides (Al₂O₃), aluminum nitrides (AlN), glass, quartz, and ferrite.

19. The thin film type common mode filter according to claim 13, wherein the insulation sheet is made of at least one material or a mixture of at least two materials selected from polyimide, epoxy resins, benzocyclobutene (BCB), and polymers.

20. The thin film type common mode filter according to claim 13, further comprising:
insulation films disposed between the first laminate and the core magnetic layer and between the second laminate and the second magnetic substrate.

21. The thin film type common mode filter according to claim 14, further comprising:
external electrode terminals which are connected to one end and the other end of the primary coil pattern electrode and one end and the other end of the secondary coil pattern electrode, respectively.
